(19) United States
(12) Patent Application Publication
(10) Pub. No.: US 2006/0112948 A1
(43) Pub. Date: Jun. 1, 2006

(54) Warming apparatus

(76) Inventors: John Ducate SR., Elgin, SC (US); Thomas Felts, Cashiers, NC (US); John Ducate JR., Columbia, SC (US)

Correspondence Address: MCNAIR LAW FIRM, P.A., P.O. BOX 10827, GREENVILLE, SC, 29603-0827, US

(21) Appl. No.: 11/268,049

(22) Filed: Nov. 7, 2005

Related U.S. Application Data
(60) Provisional application No. 60/625,641, filed on Nov. 5, 2004.

(51) Int. Cl. F24B 3/00; A47J 37/00

(52) U.S. Cl. 126/25 R; 126/307 R

(57) ABSTRACT

The invention is directed towards a cooking appliance having a frame and a burner box having a cooking area and a heating area. The cooking appliance also has a warming area located below the burner box. A warming drawer that is in fluid communication with the heating area is carried by the frame and located in the warming area. A chimney member is carried by the frame and is in fluid communication with the heating area. The chimney member includes an upper opening in fluid communication with the heating area and a lower opening that is in fluid communication with the warming area. The warming drawer includes a port that is adapted to be received by the lower opening of the chimney member, placing the warming drawer in fluid communication with the heating area.

### CROSS-REFERENCE TO RELATED APPLICATION

This application claims priority on provisional patent application Ser. No. 60/625,641, entitled A COOKING APPLIANCE, filed Nov. 5, 2004.

### FIELD OF THE INVENTION

The invention is directed towards an improvement to a cooking appliance, namely, a warming apparatus for use with a cooking grill.

### BACKGROUND OF THE INVENTION

The pleasures of outdoor cooking, particularly with charcoal and gas grills has been known for hundreds of years. Even with the advent of the modern kitchen, outdoor grilling remains a very popular method of cooking. However, the advantage and options of modern kitchens have caused the outdoor grill to be somewhat limited in application when compared to the modem kitchen appliances, particularly the oven. Particularly, it is advantageous to have a warming area within a cooking grill with a sufficient temperature to keep foods warm prior to serving a meal. This is particularly advantageous when keeping foods warm while waiting on other foods to complete preparation so that the meal can all be served warm at once.

There have been some efforts to improve upon the outdoor grill to provide modern conveniences such as shown in U.S. Pat. No. 5,213,027 which shows a cooking grill with a side burner which results in an open flame external to the burner box of the grill and a warming drawer located beneath the main cooking area. However, the warming drawer can only be heated by radiation from the bottom of the main cooking area and therefore has significantly lower heating ability than if directly heated. By not having a direct heat source from the main cooking area, this invention does not adequately provide a warming drawer having sufficient features. Further, significant heat is lost since the warming drawer is warmed by heat radiating from the main cooking chamber without a direct heat source.

Efforts to provide for direct heated warming drawers have led to inventions such as shown in U.S. Pat. No. 6,166,353 for an electrically heated warming drawer. However, this invention is not incorporated with the cooking grill. Notably, this invention does not take advantage of the heat generated from the heat source of the burner but requires a separate powered heat source.

Therefore, the need for providing a warming area to be used in cooperation with a cooking appliance that has direct heating and can benefit from the heat source of a cooking appliance's heat source is needed.

### SUMMARY OF THE INVENTION

The invention is directed to an improvement for a cooking appliance having a heating area and a warming area comprising a chimney member for being carried by the cooking appliance, an upper opening defined in the chimney member for being arranged in fluid communication with the heating area of the cooking appliance and a lower opening defined in the chimney member for being arranged in fluid communication with the warming area so that heat from the heating area can escape through the chimney member into the warming area.

The improvement for a cooking appliance further includes a warming drawer for being carried by the cooking appliance, disposed within the warming area, and in fluid communication with the lower opening for allowing heat to escape from the heating area through the chimney member and into the warming drawer.

The improvement further including a port carried by the warming drawer for being received by the lower opening for allowing heat to escape from the heating area through the chimney member into the warming drawer.

The improvement further having a door pivotally carried by the chimney member having a first position and a second position, the door placed in the first position when the lower opening receives the port allowing heat to escape from the chimney member into the warming drawer.

A cooking appliance comprising a frame, a cooking area, a cooking surface that separates the cooking area from a heating area, a heat source and a warming area located below a burner box, and a bottom plate disposed between the burner box. The frame may be a standard grill housing having four sides, a bottom, and a flip-top or removable lid. A warming drawer can be disposed in the warming area.

The invention is further directed towards a cooking appliance comprising a frame, a burner box carried by the frame, a burner box opening defined in the burner box, a chimney member having an upper opening and a lower opening, the upper opening being in fluid communication with the burner box opening so that heat may escape from the burner box into the chimney member, and a warming drawer carried by the frame in fluid communication with the lower opening of the chimney member so that heat may escape from the chimney member into the warming drawer thus allowing articles placed in the warming drawer to be heated.

The cooking appliance further includes a door pivotally carried by the chimney member having a first position for allowing heat to escape from the lower opening of the chimney member to the warming drawer and a second position for inhibiting heat from escaping from the lower opening.

The cooking appliance may include a port carried by the warming drawer for being received in the lower opening of the chimney member allowing heat to escape from the chimney member into the warming drawer and placing the door in the first position.

The cooking appliance may include a bottom plate included in the burner box and the burner box opening defined in the bottom plate allowing heat to escape from the burner box into the chimney member.

The cooking appliance further includes a heating area defined within the burner box so that heat may escape from the heating area into the chimney member.

The cooking appliance further includes a bottom plate included in the burner box and the burner box opening defined in the bottom plate allowing for heat to escape from the burner box into the chimney member.

### DESCRIPTION OF THE DRAWINGS

FIG. 1A is a perspective view of a grill with a cut away showing the invention;

FIG. 1B is a cross section of a grill showing the invention;

FIG. 2A is a perspective view of a warming drawer in fluid communication with a chimney member;

FIG. 2B is a prospective view of a warming drawer not in fluid communication with a chimney member;

FIG. 3 is a perspective view of the warming drawer having a port; and,

FIG. 4 is a perspective view of a chimney member.

### DETAILED DESCRIPTION OF THE INVENTION

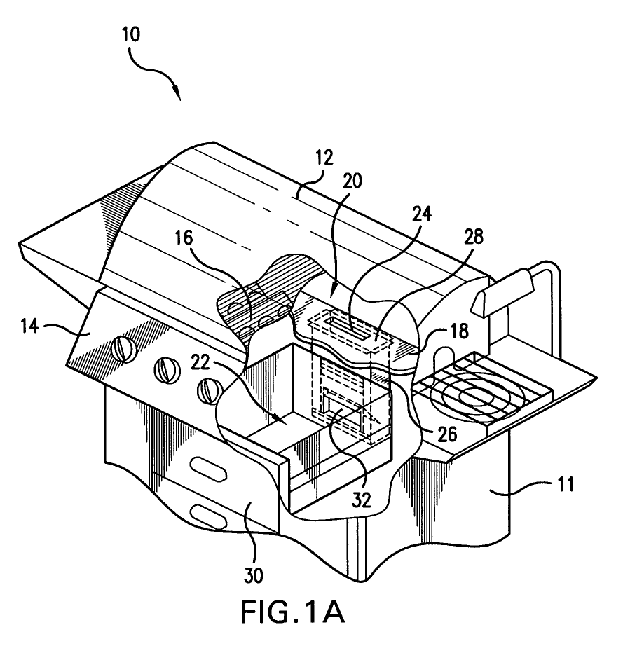

Referring now to FIGS. 1A and 1B, a cooking assembly shown generally as 10 includes a top 12 that is pivotally carried by the frame, shown generally as 11, so that the lid is able to be easily opened and closed. The cooking assembly can also include a burner box 13 which includes a cooking area 15 defined as the area above the cooking surface 16 but below lid 12, and a heating area 20 which is defined as the area below the cooking surface 16, but above bottom plate 18 of the burner box 13. Located within heating area 20 is a heat source, which in the case of a gas grill is a burner assembly 14 which includes at least one burner (not shown) having a plurality of ports for the escaping gas. The burner assembly is carried by the frame 11 so that at least one burner extends into heating area 20.

Bottom plate 18 of the burner box is carried by the frame and separates heating area 20 of burner box 13 from a warming area shown generally as 22. A burner box opening 24 can be defined in bottom plate 18 for allowing air heated in heating area 20 by the heat source to pass through burner box opening 24 and a chimney member 26. The chimney member is carried by the frame and can be partially disposed in heating area 20. The chimney member can be carried by bottom plate 18 so that an upper opening 28 of the chimney member can align with burner box opening 24 formed in bottom plate 18 to allow heated air to flow from heating area 20 into chimney member 26 and into the warming area 22. The chimney member can also have the upper opening located on its front surface and be aligned with burner box opening defined in the back of the burner box. Therefore, with little modification, the chimney member can be added to an existing cooking appliance by modification of the back of the burner box. Heated air can escape from the chimney member through a lower opening 32 in the chimney member that can be adapted to receive a warming drawer 30 disposed in the warming area, so that heated air can pass through second lower opening 32 and into warming drawer 30.

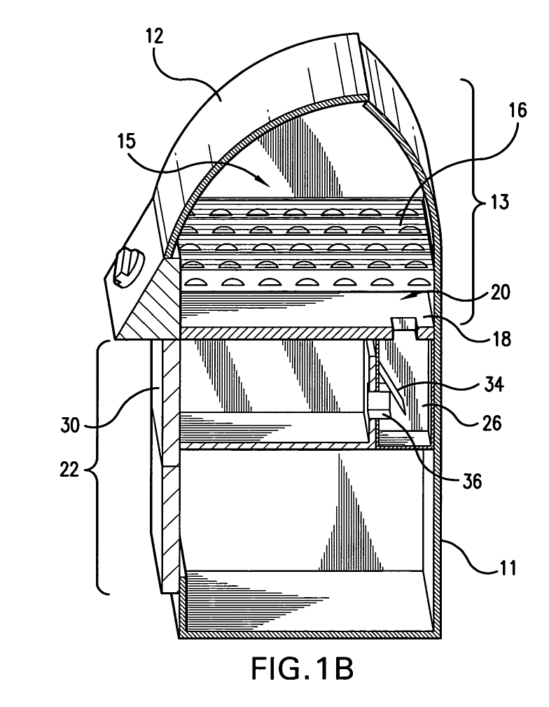

As can be seen in FIGS. 2A and 2B, warming drawer 30 is defined by four drawer panels and a drawer bottom. The back panel of the warming drawer can include a port 36 having an opening 38. The port can be adapted to be received by lower opening 32 of chimney member 26 so that when the warming drawer is closed, port member 36 extends into and is received by the lower opening of chimney member 26, thus allowing heated air from the heat source to escape into the warming drawer and warm articles placed in the warming drawer.

Lower opening 32 can be formed in the front panel of the chimney member as well as in the bottom of the chimney member.

When the lower opening is located in the bottom of the chimney member, the warming area 22 and/or or warming drawer 30 can be disposed beneath the chimney member so that heated air escapes downward from the chimney member through lower opening 32 and into the warming area and/or warming drawer. The warming drawer can also have a lid adapted to cover the warming drawer, and/or to have the port defined in the top to allow heated air to enter the warming drawer from the chimney member. A door 34 can be pivotally connected to chimney member 26 to cover lower opening 32 so that when warming drawer 30 is in a closed position, as shown in FIG. 2A, the warming drawer or port places the door in a first position allowing heated air to pass into warming drawer 30 through port 36. However, when the warming drawer is in an opened position, as shown in FIG. 2B, door 34 is in a second position that inhibits the escape of heated air into the warming drawer.

The width of door 34 can be at least a portion smaller than the width of the chimney member. When engaged, port 36 carried by warming drawer 30 causes door 34 to swing inwardly into chimney member 26, placing the door in a first position and allowing heated air to pass around the door and into the warming drawer. Further, port 36 is of such a dimension that when chimney member 26 is engaged by warming drawer 30, port 36 does not extend so far into the chimney member 26 that it would prevent or otherwise prohibit the passage of heated air into warming drawer 30.

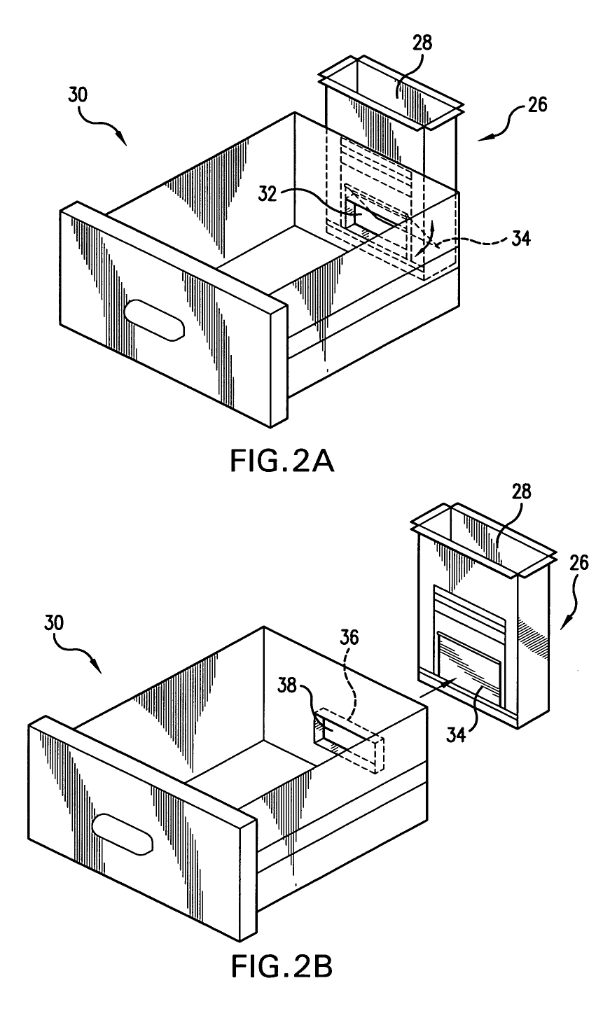

Referring now to FIG. 3, the port is shown with dimensions that are substantially the same as the dimensions of chimney member's lower opening 32 so that when engaged, air may pass into warming drawer 30, rather than generally in warming area 22. However, in alternate embodiments, heated air could pass through lower opening 32 in chimney member 26 and generally into warming area 22 without the need for a warming drawer.

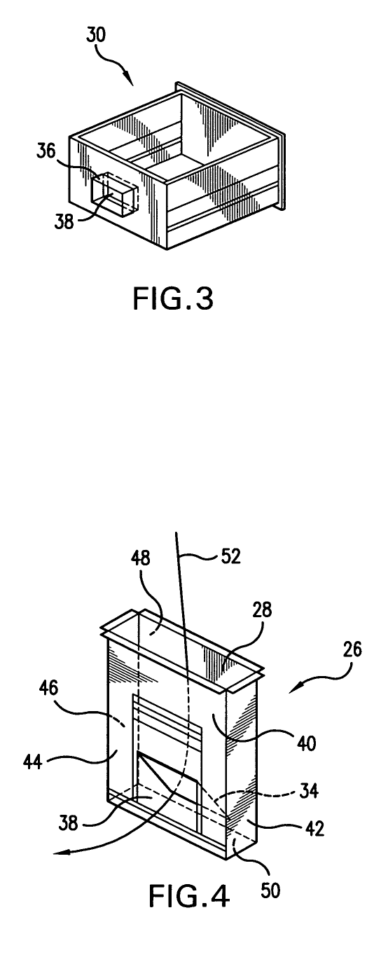

Referring now to FIG. 4, the chimney member is defined by a first side 42, a second side 46, a front side 40, a back side 48, and a bottom side 50. The chimney member defines upper opening 28 to allow heated air to enter the chimney member. Front side 40 of the chimney member can define lower opening 38 which can be secured by door 34 that can be pivotally connected to the chimney member. Lower opening 32 can be adapted to receive port 36 of warming drawer 30 such that when received, heated air can flow generally in a path 52 allowing heated air to flow from heating area 20, into chimney member 26, through first upper opening 28, around door 34, through lower opening 38, and into warming drawer 30 through port 36.

While the shown embodiment of chimney member 26 has four sides and a bottom, many alternate embodiments of the chimney member could be used. For instance, the chimney member could include two or three sides and a bottom, wherein the frame of the grill provides the back side of the chimney member. Further, the chimney member could be oval or circular or have a plurality of sides. Even upper and lower openings 28 and 32 could be a shape other than square or rectangular.

Modifications to the present invention may occur to those of ordinary skill in the art. Accordingly, it is to be understood that the present invention is not limited to the particular embodiments disclosed herein, but rather is intended to cover all modifications within the scope of the present invention as set forth in the following claims.

What is claimed is:

1. A cooking appliance comprising:
a frame;
a burner box carried by said frame;
a burner box opening defined in said burner box;
a chimney member having an upper opening and a lower opening, said upper opening being in fluid communication with said burner box opening so that heat may escape from said burner box into said chimney member; and
a warming drawer carried by said frame in fluid communication with said lower opening of said chimney member so that heat may escape from said chimney member into said warming drawer allowing articles placed in said warming drawer to be heated.

2. The invention of claim 1 including a door pivotally carried by said chimney member having a first position for allowing heat to escape from said lower opening of said chimney member to said warming drawer and a second position for inhibiting heat from escaping from said lower opening.

3. The invention of claim 2 including a port carried by said warming drawer for being received in said lower opening of said chimney member and placing said door in said first position.

4. The invention of claim 1 including a port carried by said warming drawer for being received in said lower opening allowing heat to escape from said chimney member into said warming drawer.

5. The invention of claim 1 including:
a bottom plate included in said burner box; and
said burner box opening defined in said bottom plate allowing heat to escape from said burner box into said chimney member.

6. A cooking appliance comprising:
a frame;
a burner box carried by said frame;
a burner box opening defined in said burner box;
a chimney member having an upper opening and a lower opening, said upper opening being in fluid communication with said burner box so that heat may escape from said burner box into said chimney member; and
a warming area carried by said frame, in fluid communication with said lower opening of said chimney member so that heat may escape from said chimney member into said warming area allowing for articles placed in said warming area to be heated.

7. The invention of claim 6 including a warming drawer carried by said frame and disposed within said warming area and in fluid communication with said lower opening so that heat can escape from said burner box through said chimney member and into said warming drawer allowing for articles placed in said warming drawer to be heated.

8. The invention of claim 6 including a door pivotally carried by said chimney member having a first position and a second position, said first position allowing heat to escape through said lower opening of said chimney member and said second position inhibiting heat from escaping through said lower opening of said member.

9. The invention of claim 8 including a port carried by said warming drawer for being received by said lower opening so that said door is in said first position when said lower opening receives said port and in said second position when said port is disposed away from said lower opening.

10. The invention of claim 6 including a port carried by said warming drawer for being received by said lower opening so that heat can escape from said chimney member into said warming drawer.

11. The invention of claim 6 including a heating area defined within said burner box so that heat may escape from said heating area into said chimney member.

12. The invention of claim 6 including:
a bottom plate included in said burner box; and,
said burner box opening defined in said bottom plate allowing for heat to escape from said burner box into said chimney member.

13. An improvement for a cooking appliance having a heating area and a warming area comprising:
a chimney member for being carried by the cooking appliance;
an upper opening defined in said chimney member for being arranged in fluid communication with said heating area of said cooking appliance; and
a lower opening defined in said chimney member for being arranged in fluid communication with said warming area so that heat from said heating area can escape through said chimney member into said warming area.

14. The invention of claim 13 including a warming drawer for being carried by the cooking appliance, disposed within said warming area, and in fluid communication with said lower opening for allowing heat to escape from said heating area through said chimney member and into said warming drawer.

15. The invention of claim 14 including a port carried by said warming drawer for being received by said lower opening for allowing heat to escape from the heating area through said chimney member into said warming drawer.

16. The invention of claim 13 having a door pivotally carried by said chimney member having a first position and a second position, said door placed in said first position when said lower opening receives said port allowing heat to escape from said chimney member into said warming drawer.
